(19) United States
(12) Patent Application Publication
(10) Pub. No.: US 2025/0334731 A1
(43) Pub. Date: Oct. 30, 2025

(54) COMPOSITE PHOSPHOR CERAMIC OPTICAL FIBER WITH HIGH LUMINOUS EFFICIENCY AND HIGH COLOR RENDERING INDEX, AND PREPARATION METHOD THEREFOR

(71) Applicants: Jiangsu Normal University, Xuzhou (CN); Jiangsu Xiyi Advanced Materials Research Institute Of Industrial Technology Co., LTD, Xuzhou (CN); Xuzhou All To Photoelectric Technology Co., LTD, Xuzhou (CN); Suzhou University of Science and Technology, Suzhou (CN)

(72) Inventors: Le ZHANG, Xuzhou (CN); Mingyuan LIU, Xuzhou (CN); Lv ZHU, Xuzhou (CN); Cong WEI, Xuzhou (CN); Cen SHAO, Xuzhou (CN); Jian KANG, Xuzhou (CN); Chunming ZHOU, Xuzhou (CN); Tianyuan ZHOU, Xuzhou (CN); Hao CHEN, Suzhou (CN); Guocan HUANG, Xuzhou (CN)

(21) Appl. No.: 19/258,868

(22) Filed: Jul. 2, 2025

Related U.S. Application Data
(63) Continuation of application No. PCT/CN2023/117951, filed on Sep. 11, 2023.

(30) Foreign Application Priority Data
Jan. 6, 2023 (CN) 202310016472.5

(51) Int. Cl. F21V 8/00; C04B 35/622; C04B 35/64; G02B 1/02; G02B 6/02

(52) U.S. Cl. CPC G02B 6/0003; C04B 35/62272; C04B 35/64; G02B 1/02; G02B 6/02; C04B 2235/524

(57) ABSTRACT

A composite phosphor ceramic optical fiber with luminous efficiency and color rendering index includes a phosphor ceramic fiber core and a phosphor ceramic cladding, the phosphor ceramic fiber core uses a yellow phosphor ceramic doped with Ce ions, and the phosphor ceramic cladding uses a red phosphor ceramic co-doped with ions. The composite phosphor ceramic fiber is prepared by the gel casting. With this design structure, not only can the energy transfer between Ce ions and other ions cause a red shift in the spectrum to improve the color rendering index, but also the luminous efficiency can be significantly enhanced. In addition, a diameter of the composite phosphor ceramic optical fiber matches a laser spot size very well, effectively solving the “yellow ring effect” problem caused by the mismatch. It can effectively solve the heat dissipation problem during high power LD pumping and is conducive to long term stable lighting.

### CROSS-REFERENCE TO RELATED APPLICATIONS

This application is a continuation of International Patent Application No. PCT/CN 2023/117951, filed on Sep. 11, 2023, which claims the priority of Chinese Patent Application No. 202310016472.5, filed on Jan. 6, 2023, both of which are herein incorporated by reference in their entirety.

### TECHNICAL FIELD

The disclosure relates to optical fiber materials, and particularly to a composite phosphor ceramic optical fiber with high luminous efficiency and high color rendering index and a preparation method therefor, which relates to the field of laser lighting technologies.

### BACKGROUND

Laser lighting sources are lighting solutions based on semiconductor lasers and phosphor conversion materials. The principle of the laser lighting sources involves combining blue laser diodes (LDs) with yellow phosphor materials to produce white light. In pursuit of high-power LD excitation to achieve a preparation of high-luminous flux light sources, the phosphor materials need to possess better thermal conductivity to withstand the impact of high-power density lasers. Traditional phosphor powders (i.e., phosphor-in-resin) difficult to meet such requirements, while ceramic phosphors have high thermal conductivity and are easy to be prepared into complex shapes, thus they have become an optimal material for combination with the blue LDs.

However, in laser white-light sources, the narrow blue light spectrum and the lack of red light components result in a low color rendering index, which limits their application in the field of lighting. To address the problem, researchers have proposed several solutions. For example, doping ions such as gadolinium ions (Gd³⁺), magnesium ions (Mg²⁺), and silicon ions (Si⁴⁺) into a garnet system can cause a red shift in an emission spectrum of the ceramic phosphors. Although the method improves the color rendering index to some extent, the luminous efficiency is reduced due to an alteration of a crystal structure. Another method is to increase the red emission spectrum of the ceramic phosphors by doping elements such as chromium (Cr) and manganese (Mn). However, these ions can transfer energy to cerium (Ce) ions, leading to a decrease in the luminescence intensity of the Ce ions. Therefore, many studies have focused on improving the color rendering index at an expense of reduced luminous efficiency.

In order to achieve higher luminous efficiency and a high color rendering index, researchers have conducted new shapes on the phosphors. A paper (Atul Kumar Dubey et al., Blue laser diode-pumped Ce: YAG phosphor-coated cylindrical rod-based extended white light source with uniform illumination, Laser Physics, 20 Mar. 2019, Volume 29, Number 5, 29(2019)056203) proposed a laser-based white light illumination source with uniform emission. The system innovatively uses an acrylic rod as the support for phosphor powders. Based on a principle of total internal reflection of light, a distribution of blue laser around the transparent acrylic rod is very uniform. At this time, by spin-coating the phosphor powders around the acrylic rod, a more uniform white light distribution can be obtained. However, the method in the paper has the following problems: (1) The laser and the phosphor material are connected through a lens and cannot be separated. When in use, the whole unit needs to be placed in a cold storage, where water mist can severely affect the normal operation of the laser. (2) The phosphor powders encapsulated in silicone are used as the light emitting body. Since the phosphor powders encapsulated in silicone or titanium dioxide (TiO₂) are opaque, a luminous efficiency of the light source is relatively low. In addition, due to the small area of the LD beam, after entering a phosphor body, it will directly pass through a central part of the phosphor body to form white light, while the surrounding parts with less blue light are not fully excited to form a “yellow ring”. Therefore, in view of the above mentioned problems, it is necessary to propose a light source system with a higher color rendering index and luminous efficiency to meet the lighting requirements.

Fiber-optic lighting is a high-tech lighting technology that has emerged in recent years. By utilizing the transmission of fiber-optic conductors, the light source can be conducted to any position within the fiber-optic. There are two types of application methods: an end face emission and a volume emission. At present, there are few research reports on laser lighting based on phosphor ceramic optical fiber. There are also technical problems in preparation methods, such as immature processes and difficulties in industrial mass production.

### SUMMARY

In view of the problems in the related art, a purpose of the disclosure is to provide a composite phosphor ceramic optical fiber with high luminous efficiency and high color rendering index, and a preparation method therefor. By designing a diameter of the composite phosphor ceramic optical fiber to match a laser spot size very well, the “yellow ring effect” caused by mismatch between the laser spot size and the ceramic luminescent surface is effectively solved. The composite structure realizes excellent lighting effects of high luminous efficiency and high color rendering index. In addition, the strong heat dissipation capacity of the composite phosphor ceramic optical fiber is conducive to long-term stable lighting.

To achieve above purpose, the technical solutions of the disclosure are as follows.

In an embodiment, a composite phosphor ceramic optical fiber with high luminous efficiency and high color rendering index is provided, which includes a phosphor ceramic fiber core and a phosphor ceramic cladding. A chemical formula of the phosphor ceramic fiber core is (RE₁₋ₓCex)₃Al₅O₁₂, and 0.00013≤x≤0.005, and RE represents yttrium (Y) or lutetium (Lu); and a chemical formula of the phosphor ceramic cladding is (A_{1-y}Ce_{y})₃(Al_{1-z}B_{z})₅O₁₂, and 0.001≤y≤0.01, 0.001≤z<0.08, A represents Y or Lu, and B represents manganese (Mn) or chromium (Cr). A diameter of the composite phosphor ceramic fiber is in a range of 0.15 millimeters (mm) to 1 mm, and a diameter of the phosphor ceramic fiber core is in a range of 0.05 mm to 0.2 mm.

The composite phosphor ceramic optical fiber has a transmittance of 80.0% to 84.0% at a wavelength of 800 nanometers (nm). When end-face pumped with 20 watts (W) blue light, and the blue light spot is adjusted to match a cross-section of the composite phosphor ceramic optical fiber, the composite phosphor ceramic optical fiber can produce high-quality white light with a luminous efficiency of 200 lumen per watt (lm/W) to 260 lm/W and a color rendering index (CRI) of 75 to 85.

In an embodiment, a preparation method of the composite phosphor ceramic optical fiber with luminous efficiency and color rendering index includes steps as follows.

In step (1), high purity oxide raw material powders (i.e., first oxide raw material powders) are weighed according to a chemical stoichiometric ratio of each element in the chemical formula (RE₁₋ₓCex)₃Al₅O₁₂, where 0.0001≤x≤0.005, of the phosphor ceramic fiber core, then the high purity oxide raw material powders are mixed to obtain first mixed powder, and sintering aids, a dispersant, grinding balls, and anhydrous ethanol are added into the first mixed powder to form a first premix solution, and the first premix solution is ball-milled to obtain a first mixed slurry. After the ball-milling is completed, the first mixed slurry is dried, and followed by sieving and removing impurities to obtain fiber core ceramic powder for gel casting.

In step (2), high purity oxide raw material powders (i.e., second oxide raw material powders) are weighed according to a chemical stoichiometric ratio of each element in the chemical formula (A_{1-y}Ce_{y})₃(Al_{1-z}B_{z})₅O₁₂, where 0.001≤y≤0.01 and 0.001≤z≤0.08, of the phosphor ceramic cladding, then the high purity oxide raw material powders are mixed to obtain second mixed powder, and the sintering aids, the dispersant, the grinding balls, and the anhydrous ethanol are added into the second mixed powder to form a second premix solution, and the second premix solution is ball-milled to obtain a second mixed slurry. After the ball-milling is completed, the second mixed slurry is dried, followed by sieving and removing impurities to obtain cladding ceramic powder for gel casting.

In step (3), the fiber core ceramic powder obtained in the step (1) and the cladding ceramic powder obtained in the step (2) are prepared into a slurry for preparing the phosphor ceramic fiber core and a slurry for preparing the phosphor ceramic cladding in a gel system, respectively. Then the slurry for preparing the phosphor ceramic fiber core is vacuum defoamed to obtain a defoamed slurry, and the defoamed slurry is injected into a fine-diameter capillary glass tube (i.e., first capillary glass tube), the defoamed slurry injected in the first capillary glass tube is dried to form a phosphor ceramic optical fiber green body, and the phosphor ceramic optical fiber green body is debinded, vacuum-sintered, annealed, and polished to obtain the phosphor ceramic fiber core.

In step (4), the phosphor ceramic fiber core obtained in the step (3) is placed in a center of a coarse-diameter capillary glass tube (i.e., second capillary glass tube) and the slurry for preparing the phosphor ceramic cladding are injected around the phosphor ceramic fiber core, and the slurry for preparing the phosphor ceramic cladding injected around the phosphor ceramic fiber core is dried, debinded, vacuum-sintered, annealed, and polished to obtain the composite phosphor ceramic optical fiber.

In an embodiment, in the step (1) and the step (2), the sintering aids are magnesium oxide (MgO) and tetraethyl orthosilicate (TEOS), and an amount added of the MgO is in a range of 0.2 weight percent (wt %) to 0.7 wt % of a total weight of the first oxide raw material powders or the second oxide raw material powders, and an amount added of the TEOS is in a range of 0.4 wt % to 0.6 wt % of the total weight of the first oxide raw material powders or the second oxide raw material powders. The dispersant is polyethyleneimine (PEI), and an amount added of the PEI is in a range of 0.2 wt % to 0.5 wt % of the total weight of the first oxide raw material powders or the second oxide raw material powders. A speed of the ball-milling is in a range of 170 revolutions per minute (r/min) to 260 r/min, and a time of the ball-milling is in a range of 24 hours (h) to 36 h.

In an embodiment, in the step (1) and the step (2), a temperature of the drying is in a range of 50 Celsius degrees (° C.) to 120° C., a mesh size of the sieving is in a range of 80 mesh to 300 mesh, and a temperature of the removing impurities is in a range of 800° C. to 1100° C.

In an embodiment, the gel system in the step (3) is one of an acrylamide system, a methacrylamide system, and a polyfunctional isocyanate bulk gel material (PIBM) system, and a solid content of each of the slurry for preparing the phosphor ceramic fiber core and the slurry for preparing the phosphor ceramic cladding is in a range of 52 volume percentage (vol %) to 56 vol %.

In an embodiment, in the step (3) and the step (4), a temperature of the drying is in a range of 25° C. to 60° C., and a time of the drying is in a range of 12 h to 48 h, and the debinding includes that room temperature is heated to 500° C. at a rate of 0.2 Celsius degrees per minute (° C./min) to 5° C./min, followed by heating to 900° C. at a rate of 5° C./min to 10° C./min, and 900° C. is held for 5 h to 8 h.

In an embodiment, in the step (3) and the step (4), a temperature of the vacuum-sintering is in a range of 1700° C. to 1800° C., and a holding time of the temperature of the vacuum-sintering is in a range of 8 h to 20 h.

In an embodiment, in the step (3) and the step (4), a temperature of the annealing is in a range of 1400° C. to 1450° C., and a holding time of the temperature of the annealing is in a range of 10 h to 20 h.

Compared to the related art, the beneficial effects of the disclosure are as follows.

(1) The phosphor ceramic optical fiber in the disclosure employs a composite structure with double layers arranged in a concentric circle manner in a radial direction. The fiber core layer (i.e., phosphor ceramic fiber core) uses yellow phosphor ceramics doped with Ce ions, and the cladding (i.e., phosphor ceramic cladding) uses red phosphor ceramics co-doped with ions. This design structure not only enables energy transfer between Ce ions and other ions, causing a red shift in the spectrum to improve the color rendering index, but also significantly enhances the luminous efficiency. Moreover, the fiber diameter is well-matched with the laser spot size, resulting in excellent lighting effects.

(2) The disclosure applies a gel-casting method to prepare the fiber core layer and the composite phosphor optical fiber in sequence, effectively bonding the fiber core layer and the cladding closely together. An overall quality of the composite phosphor ceramic optical fiber is improved by controlling the temperature of the sintering. Additionally, this preparation method can achieve mass production at a low cost, which is conducive to the industrialization of the composite phosphor ceramic optical fiber preparation.

(3) Leveraging the advantages of the fiber structure, the fiber end face is well-matched with the laser spot size, effectively solving the “yellow ring effect” caused by the mismatch between the laser spot size and the ceramic luminescent surface. By converting a portion of the blue light beam into white light and another portion undergoing “total internal reflection” within the fiber, the extraction efficiency of blue light is effectively enhanced. Moreover, the heat dissipation problem during high-power LD pumping can be effectively addressed, which is beneficial for long-term stable lighting.

### BRIEF DESCRIPTION OF DRAWINGS

FIG. 1 illustrates a schematic diagram of a structure and a luminescence mechanism of a composite phosphor ceramic optical fiber in the disclosure.

FIG. 2 illustrates a process flowchart of a preparation method of the composite phosphor ceramic optical fiber in the disclosure.

FIG. 3 illustrates an electroluminescent (EL) spectrum of the composite phosphor ceramic optical fiber under blue light excitation with 20 W in an embodiment 1 of the disclosure.

FIG. 4 illustrates a variation curve diagram of luminous efficiency of the composite phosphor ceramic optical fiber under the blue light excitation in the embodiment 1 of the disclosure.

### DETAILED DESCRIPTION OF EMBODIMENTS

The disclosure will be further described in detail with reference to the attached drawings and specific embodiments.

### Embodiment 1

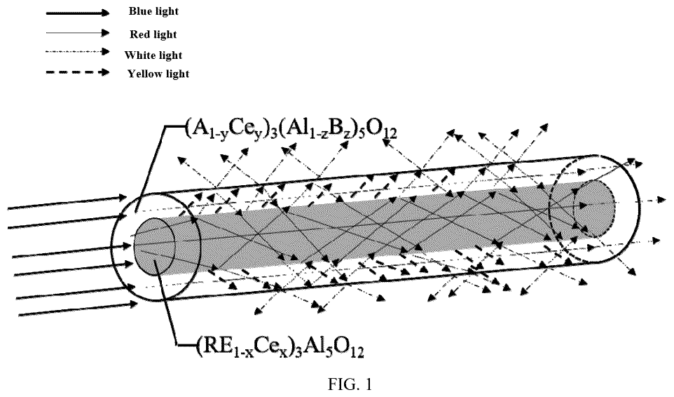

A structure of a composite phosphor ceramic optical fiber with high luminous efficiency and high color rendering index is shown in FIG. 1, and the composite phosphor ceramic optical fiber includes a phosphor ceramic fiber core and a phosphor ceramic cladding. A chemical formula of the phosphor ceramic fiber core is (Y_{0.9999}Ce_{0.0001})₃Al₅O₁₂, and a chemical formula of the phosphor ceramic cladding is (Y_{0.999}Ce_{0.001})₃(Al_{0.999}Mn_{0.001})₅O₁₂. A diameter of the entire composite phosphor ceramic optical fiber is 0.15 mm, a length of the entire composite phosphor ceramic optical fiber is 100 mm, and a diameter of the phosphor ceramic fiber core is 0.05 mm.

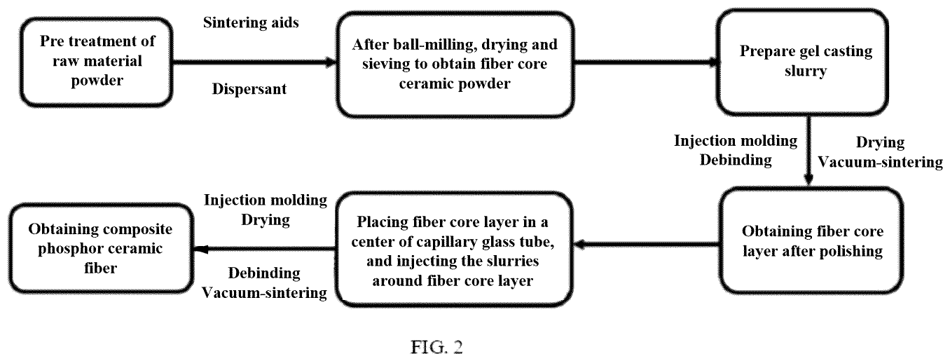

A preparation method of the composite phosphor ceramic optical fiber is shown in FIG. 2, which includes steps as follows.

(1) 125 grams (g) of high purity yttrium oxide (Y₂O₃), aluminum oxide (Al₂O₃), and cerium oxide (CeO₂) raw material powders (i.e., first oxide raw material powders) are weighed according to a chemical stoichiometric ratio of each element in the chemical formula (Y_{0.9999}Ce_{0.0001})₃Al₅O₁₂of the phosphor ceramic fiber core. The raw material powders are mixed to obtain first mixed powder, and sintering aids (0.25 g MgO and 0.5 g TEOS), a dispersant (0.625 g PEI), Al₂O₃ grinding balls, and anhydrous ethanol are added into the first mixed powder to form a first premix solution. The first premix solution is placed in a ball mill can and ball-milled at 170 r/min for 24 h with a ball-to-material ratio of 5:1 to obtain a first mixed slurry. After the ball-milling is completed, the first mixed slurry is dried at 50° C., followed by sieved through an 80-mesh screen, and removed impurities at 800° C. to obtain fiber core ceramic powder for gel casting.

(2) 125 g of high purity Y₂O₃, Al₂O₃, CeO₂, and MnCO₃ raw material powders (i.e., second oxide raw material powders) are weighed according to a chemical stoichiometric ratio of each element in the chemical formula (Y_{0.999}Ce_{0.001})₃(Al_{0.999}Mn_{0.001})₅O₁₂ of the phosphor ceramic cladding, the raw material powders are mixed to obtain second mixed powder, the sintering aids (0.25 g MgO and 0.5 g TEOS), the dispersant (0.625 g PEI), the Al₂O₃ grinding balls, and the anhydrous ethanol are added into the second mixed powder to form a second premix solution. The second premix solution is placed in a ball mill can and ball-milled at 170 r/min for 24 h with a ball-to-material ratio of 5:1 to obtain a second mixed slurry. After the ball-milling is completed, the second mixed slurry is dried at 50° C., followed by sieved through the 80-mesh screen, and removed impurities at 800° C. to obtain cladding ceramic powder for gel casting.

(3) The fiber core ceramic powder obtained in the step (1) and the cladding ceramic powder obtained in the step (2) are respectively prepared into slurries (i.e., a slurry for preparing the phosphor ceramic fiber core and a slurry for preparing the phosphor ceramic cladding) of an acrylamide gel system, with a solid content of 52 vol %. The slurry for preparing a fiber core layer (i.e., the phosphor ceramic fiber core) is vacuum defoamed to obtain a defoamed slurry, and the defoamed slurry is injected into a fine-diameter capillary glass tube (i.e., first capillary glass tube). The defoamed slurry in the fine-diameter capillary glass tube is dried at 25° C. for 48 h to obtain a phosphor ceramic optical fiber green body. The phosphor ceramic optical fiber green body is subjected to debinding, vacuum-sintering at 1700° C. for 8 h, annealing at 1400° C. for 10 h, and finally polishing to obtain the phosphor ceramic fiber core. The debinding process includes: heating from the room temperature to 500° C. at a rate of 0.2° C./min, then heating to 900° C. at a rate of 5° C./min, and holding at 900° C. for 5 h.

(4) The phosphor ceramic fiber core obtained in the step (3) is placed in a center of a coarse-diameter capillary glass tube (i.e., second capillary glass tube), and the slurry for preparing the phosphor ceramic cladding is injected around the phosphor ceramic fiber core, followed by drying, debinding, vacuum-sintering, annealing, and polishing to obtain the composite phosphor ceramic optical fiber. The drying, debinding, vacuum-sintering, and annealing mechanisms used are equivalent to the step (3).

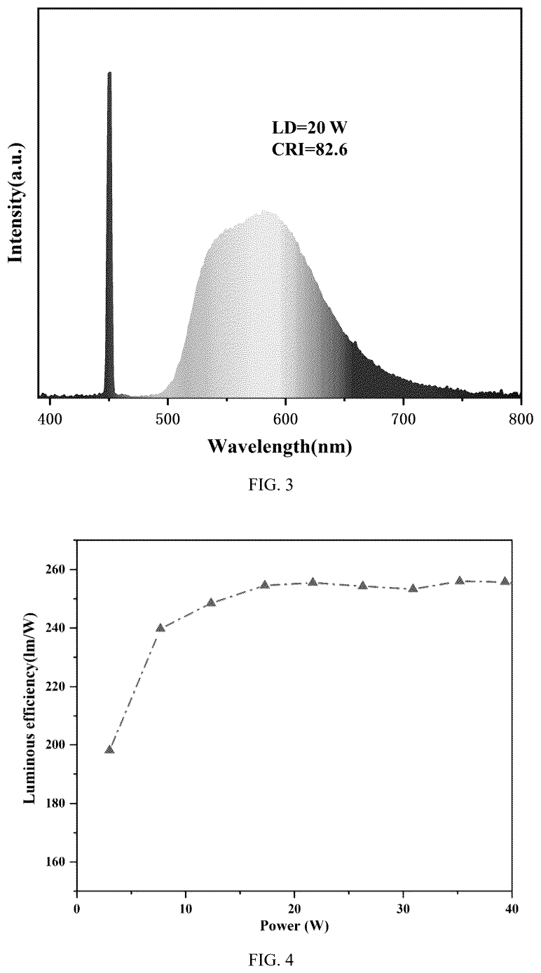

The composite phosphor ceramic optical fiber prepared in the embodiment 1 has a transmittance of 84.0% at a wavelength of 800 nm. When end-face pumped with 20 W blue light, the composite phosphor ceramic optical fiber can produce high-quality white light with a luminous efficiency of 255 lm/W and a color rendering index of 82.6 (as shown in FIGS. 3 and 4).

### Embodiment 2

A structure of a composite phosphor ceramic optical fiber with high luminous efficiency and high color rendering index is shown in FIG. 1, and the composite phosphor ceramic optical fiber includes a phosphor ceramic fiber core and a phosphor ceramic cladding. A chemical formula of the phosphor ceramic fiber core is (Lu_{0.995}Ce_{0.005})₃Al₅O₁₂, and a chemical formula of the phosphor ceramic cladding is (Y_{0.999}Ce_{0.001})₃(Al_{0.999}Mn_{0.001})₅O₁₂. A diameter of the entire composite phosphor ceramic optical fiber is 1.0 mm, a length of the entire composite phosphor ceramic optical fiber is 50 mm, and a diameter of the phosphor ceramic fiber core is 0.2 mm.

A preparation method of the composite phosphor ceramic fiber is shown in FIG. 2, which includes steps as follows.

(1) 125 g of high purity of Lu₂O₃, Al₂O₃, and CeO₂ raw material powders are weight according to a chemical stoichiometric ratio of each element in the chemical formula (Lu_{0.995}Ce_{0.005})₃Al₅O₁₂ of the phosphor ceramic fiber core. The raw material powders are mixed to obtain first mixed powder, and sintering aids (0.875 g MgO and 0.75 g TEOS), a dispersant (0.25 g PEI), Al₂O₃ grinding balls, and anhydrous ethanol are added into the first mixed powder to form a first premix solution. The first premix solution is placed in a ball mill can and ball-milled at 260 r/min for 36 h with a ball-to-material ratio being 3:1 to obtain a first mixed slurry. After the ball-milling is completed, the first mixed slurry is dried at 120° C., followed by sieved through a 300-mesh screen, and removed impurities at 1100° C. to obtain the fiber core ceramic powder for gel casting.

(2) 125 g of high purity of Y₂O₃, Al₂O₃, CeO₂, and Cr₂O₃ of raw material powders are weighed according to a chemical stoichiometric ratio of each element in the chemical formula (Y_{0.999}Ce_{0.001})₃(Al_{0.999}Mn_{0.001})₅O₁₂ of the phosphor ceramic cladding, the raw material powders are mixed to obtain second mixed powder, the sintering aids (0.875 g MgO and 0.75 g TEOS), the dispersant (0.25 g PEI), the Al₂O₃ grinding balls, and the anhydrous ethanol are added into the second mixed powder to form a second premix solution. The second premix solution is placed in a ball mill can and ball-milled at 260 r/min for 36 h with a ball-to-material ratio being 3:1 to obtain a second mixed slurry. After the ball-milling is completed, the second mixed slurry is dried at 120° C., followed by sieved through the 300-mesh screen, and removed impurities at 1100° C. to obtain cladding ceramic powder for gel casting.

(3) The fiber core ceramic powder obtained in the step (1) and the cladding ceramic powder obtained in the step (2) are respectively prepared into slurries of a methacrylamide gel system, with a solid content of 56 vol %. The slurry for preparing a fiber core layer is vacuum defoamed to obtain a defoamed slurry, and the defoamed slurry is injected into a fine-diameter capillary glass tube. The defoamed slurry in the fine-diameter capillary glass tube is dried at 60° C. for 12 h to obtain a phosphor ceramic optical fiber green body. The phosphor ceramic optical fiber green body is subjected to debinding, vacuum-sintering at 1800° C. for 20 h, annealing at 1450° C. for 20 h, and finally polishing to obtain the phosphor ceramic fiber core. The debinding process includes: heating from the room temperature to 500° C. at a rate of 5° C./min, then heating to 900° C. at a rate of 10° C./min, and holding at 900° C. for 8 h.

(4) The phosphor ceramic fiber core obtained in the step (3) is placed in a center of a coarse-diameter capillary glass tube and the slurry for preparing the phosphor ceramic cladding is injected around the phosphor ceramic fiber core, and followed by drying, debinding, vacuum-sintering, annealing, and polishing the injected slurries of the cladding ceramic powder to obtain the composite phosphor ceramic optical fiber. The drying, debinding, vacuum-sintering, and annealing mechanisms used are equivalent to the step (3).

The composite phosphor ceramic optical fiber prepared in the embodiment 2 has a transmittance of 80.0% at a wavelength of 800 nm. When end-face pumped with 20 W blue light, the composite phosphor ceramic optical fiber can produce high-quality white light with a luminous efficiency of 200 lm/W and a color rendering index of 80.2.

### Embodiment 3

A structure of a composite phosphor ceramic optical fiber with high luminous efficiency and high color rendering index is shown in FIG. 1, and the composite phosphor ceramic optical fiber includes a phosphor ceramic fiber core and a phosphor ceramic cladding. A chemical formula of the phosphor ceramic fiber core is (Y_{0.9999}Ce_{0.0001})₃Al₅O₁₂, and a chemical formula of the phosphor ceramic cladding is (Lu_{0.995}Ce_{0.005})₃Al₅O₁₂. A diameter of the entire composite phosphor ceramic optical fiber is 0.3 mm, a length of the entire composite phosphor ceramic optical fiber is 10 mm, and a diameter of the phosphor ceramic fiber core is 0.1 mm.

A preparation method of the composite phosphor ceramic fiber is shown in FIG. 2, which includes steps as follows.

(1) 125 g of high purity of Y₂O₃, Al₂O₃, and CeO₂ raw material powders are weight according to a chemical stoichiometric ratio of each element in the chemical formula (Y_{0.9999}Ce_{0.0001})₃Al₅O₁₂of the phosphor ceramic fiber core. The raw material powders are mixed to obtain first mixed powder, and sintering aids (0.625 g MgO and 0.625 g TEOS), a dispersant (0.375 g PEI), Al₂O₃ grinding balls, and anhydrous ethanol are added into the first mixed powder to form a first premix solution. The first premix solution is placed in a ball mill can and ball-milled at 200 r/min for 30 h with a ball-to-material ratio being 1:1 to obtain a first mixed slurry. After the ball-milling is completed, the first mixed slurry is dried at 80° C., followed by sieved through a 100-mesh screen, and removed impurities at 1000° C. to obtain the fiber core ceramic powder for gel casting.

(2) 125 g of high purity of Lu₂O₃, Al₂O₃, CeO₂, and Cr₂O₃ of raw material powders are weighed according to a chemical stoichiometric ratio of each element in the chemical formula (Lu_{0.995}Ce_{0.005})₃Al₅O₁₂ of the phosphor ceramic cladding, the raw material powders are mixed to obtain second mixed powder, the sintering aids (0.625 g MgO and 0.625 g TEOS), the dispersant (0.375 g PEI), the Al₂O₃ grinding balls, and the anhydrous ethanol are added into the second mixed powder to form a second premix solution. The second premix solution is placed in a ball mill can and ball-milled at 200 r/min for 30 h with a ball-to-material ratio being 1:1 to obtain a second mixed slurry. After the ball-milling is completed, the second mixed slurry is dried at 80° C., followed by sieved through the 100-mesh screen, and removed impurities at 1000° C. to obtain cladding ceramic powder for gel casting.

(3) The fiber core ceramic powder obtained in the step (1) and the cladding ceramic powder obtained in the step (2) are respectively prepared into slurries of a PIBM gel system, with a solid content of 54 vol %. The slurry for preparing a fiber core layer is vacuum defoamed to obtain a defoamed slurry, and the defoamed slurry is injected into a fine-diameter capillary glass tube. The defoamed slurry in the fine-diameter capillary glass tube is dried at 45° C. for 24 h to obtain a phosphor ceramic optical fiber green body. The phosphor ceramic optical fiber green body is subjected to debinding, vacuum-sintering at 1780° C. for 16 h, annealing at 1420° C. for 15 h, and finally polishing to obtain the phosphor ceramic fiber core. The debinding process includes: heating from the room temperature to 500° C. at a rate of 2° C./min, then heating to 900° C. at a rate of 8° C./min, and holding at 900° C. for 7 h.

(4) The phosphor ceramic fiber core obtained in the step (3) is placed in a center of a coarse-diameter capillary glass tube and the slurry for preparing the phosphor ceramic cladding is injected around the phosphor ceramic fiber core, and followed by drying, debinding, vacuum-sintering, annealing, and polishing the injected slurries of the cladding ceramic powder to obtain the composite phosphor ceramic optical fiber. The drying, debinding, vacuum-sintering, and annealing mechanisms used are equivalent to the step (3).

The composite phosphor ceramic optical fiber prepared in the embodiment 3 has a transmittance of 82.2% at a wavelength of 800 nm. When end-face pumped with 20 W blue light, the composite phosphor ceramic optical fiber can produce high-quality white light with a luminous efficiency of 225 lm/W and a color rendering index of 75.

The above description is only a part of specific embodiments of the disclosure, but the scope of protection of the disclosure is not limited to this. Any modifications, equivalent substitutions, and improvements made by any those skilled in the art familiar with the technical field within the scope of the disclosure within the spirit and principles of the disclosure should be included in the scope of protection of the disclosure.

What is claimed is:

1. A composite phosphor ceramic optical fiber, comprising a phosphor ceramic fiber core and a phosphor ceramic cladding; wherein a chemical formula of the phosphor ceramic fiber core is (RE₁₋ₓCex)₃Al₅O₁₂, where 0.00013≤x≤0.005, and RE represents yttrium (Y) or lutetium (Lu); and a chemical formula of the phosphor ceramic cladding is (A_{1-y}Ce_{y})₃(Al_{1-z}B_{z})₅O₁₂, where 0.001≤y≤0.01, and 0.001≤z≤0.08, A represents Y or Lu, and B represents manganese (Mn) or chromium (Cr); and
wherein a diameter of the composite phosphor ceramic optical fiber is in a range of 0.15 millimeters (mm) to 1 mm, and a diameter of the phosphor ceramic fiber core is in a range of 0.05 mm to 0.2 mm.

2. A preparation method of the composite phosphor ceramic optical fiber as claimed in claim 1, comprising:
(1) weighing first oxide raw material powders according to a chemical stoichiometric ratio of each element in the chemical formula (RE₁₋ₓCex)₃Al₅O₁₂, where 0.0001≤x≤0.005, of the phosphor ceramic fiber core, mixing the first oxide raw material powders to obtain first mixed powder, adding sintering aids, a dispersant, grinding balls, and anhydrous ethanol into the first mixed powder to form a first premix solution, and ball-milling the first premix solution to obtain a first mixed slurry; after the ball-milling is completed, drying the first mixed slurry, followed by sieving and removing impurities to obtain fiber core ceramic powder for gel casting;
(2) weighing second oxide raw material powders according to a chemical stoichiometric ratio of each element in the chemical formula (A_{1-y}Ce_{y})₃(Al_{1-z}B_{z})₅O₁₂, where 0.001≤y≤0.01 and 0.001≤z≤0.08, of the phosphor ceramic cladding, mixing the second oxide raw material powders to obtain second mixed powder, adding the sintering aids, the dispersant, the grinding balls, and the anhydrous ethanol to form a second premix solution, and ball-milling the second premix solution to obtain a second mixed slurry; after the ball-milling is completed, drying the second mixed slurry, followed by sieving and removing impurities to obtain cladding ceramic powder for gel casting;
(3) preparing the fiber core ceramic powder obtained in the step (1) and the cladding ceramic powder obtained in the step (2) into a slurry for preparing the phosphor ceramic fiber core and a slurry for preparing the phosphor ceramic cladding in a gel system, respectively;
vacuum defoaming the slurry for preparing the phosphor ceramic fiber core to obtain a defoamed slurry, injecting the defoamed slurry into a first capillary glass tube, and drying the defoamed slurry injected in the first capillary glass tube to form a phosphor ceramic optical fiber green body, followed by debinding, vacuum-sintering, annealing, and polishing to obtain the phosphor ceramic fiber core; and
(4) placing the phosphor ceramic fiber core obtained in the step (3) in a center of a second capillary glass tube, injecting the slurry for preparing the phosphor ceramic cladding around the phosphor ceramic fiber core, and drying the slurry for preparing the phosphor ceramic cladding injected around the phosphor ceramic fiber core, followed by debinding, vacuum-sintering, annealing, and polishing to obtain the composite phosphor ceramic optical fiber.

3. The preparation method as claimed in claim 2, wherein, in the step (1) and the step (2), the sintering aids are magnesium oxide (MgO) and tetraethyl orthosilicate (TEOS), and an amount added of the MgO is in a range of 0.2 weight percent (wt %) to 0.7 wt % of a total weight of the first oxide raw material powders or the second oxide raw material powders, and an amount added of the TEOS is in a range of 0.4 wt % to 0.6 wt % of the total weight of the first oxide raw material powders or the second oxide raw material powders; the dispersant is polyethyleneimine (PEI), and an amount added of the PEI is in a range of 0.2 wt % to 0.5 wt % of the total weight of the first oxide raw material powders or the second oxide raw material powders; and a speed of the ball-milling is in a range of 170 revolutions per minute (r/min) to 260 r/min, and a time of the ball-milling is in a range of 24 hours (h) to 36 h.

4. The preparation method as claimed in claim 2, wherein in the step (1) and the step (2), a temperature of the drying is in a range of 50 Celsius degrees (° C.) to 120° C., a mesh size of the sieving is in a range of 80 mesh to 300 mesh, and a temperature of the removing impurities is in a range of 800° C. to 1100° C.

5. The preparation method as claimed in claim 2, wherein the gel system in the step (3) is one of an acrylamide system, a methacrylamide system, and a polyfunctional isocyanate bulk gel material (PIBM) system, and a solid content of each of the slurry for preparing the phosphor ceramic fiber core and the slurry for preparing the phosphor ceramic cladding is in a range of 52 volume percentage (vol %) to 56 vol %.

6. The preparation method as claimed in claim 2, wherein, in the step (3) and the step (4), a temperature of the drying is in a range of 25° C. to 60° C., and a time of the drying is in a range of 12 h to 48 h, and the debinding comprises:
heating from room temperature to 500° C. at a rate of 0.2 Celsius degrees per minute (° C./min) to 5° C./min, then heating to 900° C. at a rate of 5° C./min to 10° C./min, and holding at 900° C. for 5 h to 8 h.

7. The preparation method as claimed in claim 2, wherein, in the step (3) and the step (4), a temperature of the vacuum-sintering is in a range of 1700° C. to 1800° C., and a holding time of the temperature of the vacuum-sintering is in a range of 8 h to 20 h.

8. The preparation method as claimed in claim 2, wherein, in the step (3) and the step (4), a temperature of the annealing is in a range of 1400° C. to 1450° C., and a holding time of the temperature of the annealing is in a range of 10 h to 20 h.
